(19) United States
(12) Patent Application Publication
(10) Pub. No.: US 2007/0176538 A1
(43) Pub. Date: Aug. 2, 2007

(54) Continuous conductor for OLED electrical drive circuitry

(75) Inventors: Dustin L. Winters, Webster, NY (US); Yongtaek Hong, Rochester, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 11/345,735

(22) Filed: Feb. 2, 2006

(51) Int. Cl. H01J 1/62; H01J 63/04

(52) U.S. Cl. 313/504

(57) ABSTRACT

An OLED device comprising: an electrically insulating substrate; a plurality of light emitting pixels formed over the substrate wherein each pixel includes first and second spaced apart electrodes and organic electroluminescent media disposed between the first and second electrodes; a first thin film transistor associated with a first pixel and disposed above the substrate and having a gate electrode, a semiconductor region, a source terminal and a drain terminal; a continuously formed conductive layer positioned under the pixels and disposed above the substrate and disposed below the first thin film transistor and the organic electroluminescent media; an insulator layer disposed between the continuous conductor layer and the thin film transistor and having a first contact hole; and electrical connection is provided from the continuous conductor layer, through the first contact hole to either the source terminal or drain terminal of the first thin film transistor.

### CROSS REFERENCE TO RELATED APPLICATIONS

Reference is made to commonly assigned U.S. patent application Ser. No. 11/005,745 filed Dec. 7, 2004 by Dustin L. Winters, et al., entitled “OLED Displays With Varying Sized Pixels”, the disclosures of which are herein incorporated by reference.

### FIELD OF INVENTION

This invention relates to forming electrical connection between an electrode and a bus in an OLED device.

### BACKGROUND OF THE INVENTION

In the simplest form, an organic electroluminescent (EL) device is comprised of organic electroluminescent media disposed between first and second spaced apart electrodes. The first and second electrodes serve as an anode for hole injection and a cathode for electron injection. The organic electroluminescent media supports recombination of holes and electrons that yields emission of light. These devices are also commonly referred to as organic light-emitting diodes, or OLEDs. A basic organic EL element is described in U.S. Pat. No. 4,356,429. In order to construct a pixelated OLED display device that is useful as a display such as, for example, a television, computer monitor, cell phone display, personal digital assistant display, music player display, or digital camera display, individual organic EL elements can be arranged as pixels in a matrix pattern. These pixels can all be made to emit the same color, thereby producing a monochromatic display, or they can be made to produce multiple colors such as a three-pixel red, green, blue (RGB) display. For purposes of this disclosure, a pixel is considered the smallest individual unit, which can be independently stimulated to produce light visible to a viewer as a portion of an image. As such, in an RGB display the red pixel, the green pixel, and the blue pixel are considered as three distinct pixels.

The simplest pixelated OLED displays are driven in a passive matrix configuration. In a passive matrix, the organic EL material is sandwiched between two sets of electrodes, arranged orthogonally as rows and columns. An example of a passive matrix driven OLED display is described in U.S. Pat. No. 5,276,380. This approach to producing a pixelated display, however, has several disadvantages. First, only a single row (or column) is illuminated at any given time. Therefore, in order to achieve the desired average brightness for a given frame of video, the row should be illuminated to an instantaneous brightness equal to the desired average brightness multiplied by the number of rows. This results in higher voltages and reduced long term reliability compared to a situation where the pixels are capable of being lit continuously for the entire frame. Second, the combination of high instantaneous current and electrodes that are long and narrow, and therefore have high resistance, results in significant voltage drops across the device. These variations in voltage across the display adversely affect brightness uniformity. These two effects become worse as the size of the display and number of rows and columns are increased, thereby limiting the usefulness of passive matrix designs to relatively small, low resolution displays.

To resolve these problems and produce higher performance devices, OLED displays driven by active matrix (AM) circuitry have been shown. In an active matrix configuration, each pixel is driven by multiple circuit elements such transistors, capacitors, and signal lines. This circuitry permits the pixels of multiple rows to remain illuminated simultaneously, thereby decreasing the required peak brightness of each pixel. Examples of active matrix drive OLED displays are shown in U.S. Pat. Nos. 5,550,066, 5,684,365, 6,281,634, 6,456,013, 6,501,466, 6,535,185, 6,737,800 and 6,392,340, 6,753,654 and 6,798,145 and U.S. Patent Application Numbers 20050218798A1 and 20030216100A1.

These active matrix devices are commonly fabricated on large, rigid substrates that typically range from 0.1 to 4 square meters or larger in size. The most commonly used substrate is glass or, more specifically, Corning 1737 type glass or the like. Such glass substrates have many desirable properties such as mechanical strength, low moisture permeability, are electrically insulating and are capable of withstanding the processing, including chemical and high temperature exposure, used to fabricate the active matrix circuitry. Furthermore, many factories and a wide variety of processing tools are currently available to process such substrates.

The active matrix circuitry is commonly achieved by forming thin film transistors (TFT's) from thin layers of semiconductor material, such as silicon, deposited onto the substrate. The two most common types of TFT's are amorphous silicon type TFT's and polysilicon type TFT's. These TFT's are commonly fabricated using thin film deposition, photolithographic patterning, and etching techniques known in the art. Each layer of the TFT is built up using one or more, and often all three, of these techniques. Amorphous silicon TFT's are constructed by using a silicon layer with an amorphous structure. As such they tend to have low performance in terms of the their ability to conduct and are typically limited to n-type transistors, also known as NMOS. Polysilicon type TFT's are fabricated by annealing amorphous silicon at elevated temperatures to crystallize the silicon layer into a poly-crystalline state. As such, polysilcon type TFT's have better performance and can also be fabricated into both n-type (NMOS) and p-type (PMOS) transistors. A common method of annealing polysilicon type TFT's is by excimer laser annealing (ELA). However, the additional processing steps required to anneal the polysilicon and fabricate both NMOS and PMOS type transistors typically result in such polysilicon type devices having a high manufacturing cost.

In addition to the silicon layers, several metal and insulator layers are typically deposited and patterned to complete the TFT's as well as the wiring and other components such as capacitors. Commonly, two different metal layers are used. The metal layers are used to form the gate terminal and the source and drain connections to the TFT's. In addition, these two metal layers also form a mesh of wiring in both a row direction and a column direction. Since two metal layers are used with at least one insulator layer in between, the row wiring and the column wiring can be formed and electrically isolated from one and other. Typically, data signal lines are formed in one of these two metal layers while row select lines are formed in the other layer. This permits the pixels to be selected, for example, row by row while the brightness intensity data is loaded from the column direction.

Since OLED devices require a constant current supply to sustain illumination, prior art active matrix OLED devices typically provide a power line electrically connected to a voltage source to supply current to one or more rows or columns of pixels. Current is then regulated between this power line and the lower electrode of the organic light emitting diode by one or more transistors, referred to as power transistors. The circuit is completed by electrically connecting the upper electrode of the organic light emitting diode to a second voltage source, such as a ground voltage. This upper electrode is frequently common to all the pixels and does not require precision level pixel patterning or alignment.

In prior art OLED displays, this power line is formed in either of the two previously described metal layers. The signal lines formed in each of such layers are patterned into separate, electrically isolated, features during a photolithographic patterning and an etching step. By forming the power line in one of these two metal layers which are already required to form the mesh of data lines and select lines, the power lines can be formed without any additional photolithographic patterning steps. Therefore, cost to produce the display can be kept low. The prior art power lines have been arranged in either a row direction or a column direction and can be arranged to supply electrical current to one or more of such rows or columns of pixels. Such power lines are frequently formed of metals such as aluminum, aluminum alloys such as aluminum neodymium, chromium, or molybdenum. Examples of various arrangements of these power lines can be found in U.S. Pat. Nos. 6,522,079, 6,919,681, and 6,771,028.

As display sizes increase, for example, from small displays such as are useful for cellular telephones or digital cameras to large displays such as are useful for monitors or televisions, the length of these power lines and the total amount of electrical current being carried by the power lines both increase. This can result in large resistances that cause large voltage variations across the power lines from the center to the edge of the display. These voltage drops can adversely affect the luminance uniformity of the display as well as result in wasted power consumption. One method of reducing this resistance is to increase the width of the power line as described in U.S. Pat. No. 6,762,564. Another approach to improving the current supply across the panel as described in U.S. Pat. No. 6,724,149 is to provide a first set of power lines in the same metal layer as the select lines in the row direction and a second set of power lines in the same metal layer as the data lines in the column direction and connect them together to form a grid. However, both of these approaches are limited in effectiveness by the fact that the power lines must be limited in size due to other features formed in the same layers. Therefore, a new OLED display device that can provide a power supply to the pixels with reduced resistance across the display while maintaining low manufacturing cost is desired.

### SUMMARY OF THE INVENTION

It is an object of the present invention to provide an OLED display having reduced resistance to current flowing to the pixels. It is a further object of the present invention to provide an OLED display that can be easily fabricated without additional patterning or etching steps.

These objects are achieved by an OLED device including: an electrically insulating substrate; a plurality of light emitting pixels formed over the substrate wherein each pixel includes first and second spaced apart electrodes and organic electroluminescent media disposed between the first and second electrodes; a first thin film transistor associated with a first pixel and disposed above the substrate and having a gate electrode, a semiconductor region, a source terminal and a drain terminal; a continuously formed conductive layer positioned under the pixels and disposed above the substrate and disposed below the first thin film transistor and the organic electroluminescent media; an insulator layer disposed between the continuous conductor layer and the thin film transistor and having a first contact hole; and means for providing an electrical connection from the continuous conductor layer, through the first contact hole to either the source terminal or drain terminal of the first thin film transistor so that electrical current flows between the continuous conductor layer, the source terminal and drain terminal and the first and second spaced apart electrodes of the first pixel.

### BRIEF DESCRIPTION OF THE DRAWINGS

FIG. 1 depicts a prior art circuit diagram for a portion of an OLED display;

FIG. 2 depicts a layout diagram illustrating the arrangement and construction of the drive circuitry components of a prior art OLED display device;

FIG. 3 depicts a cross sectional view of the prior art OLED display device;

FIG. 4a-4b depict cross sectional views an OLED display device according to the first embodiment of the present invention;

FIG. 5 depicts a layout diagram illustrating the arrangement and construction of the drive circuitry components of an OLED display device according to the first embodiment of the present invention;

FIG. 6 depicts a circuit diagram for a portion of an OLED display device according to the present invention;

FIG. 7 depicts a process flow for fabricating an OLED display device according to the present invention;

FIG. 8 depicts a layout diagram illustrating the arrangement and construction of the drive circuitry components of an OLED display device according to the second embodiment of the present invention;

FIG. 9 depicts a layout diagram illustrating the arrangement and construction of the drive circuitry components of an OLED display device according to the third embodiment of the present invention.

Since feature dimensions such as layer thicknesses are frequently in sub-micrometer ranges, the drawings are scaled for ease of visualization rather than dimensional accuracy.

### DETAILED DESCRIPTION OF THE INVENTION

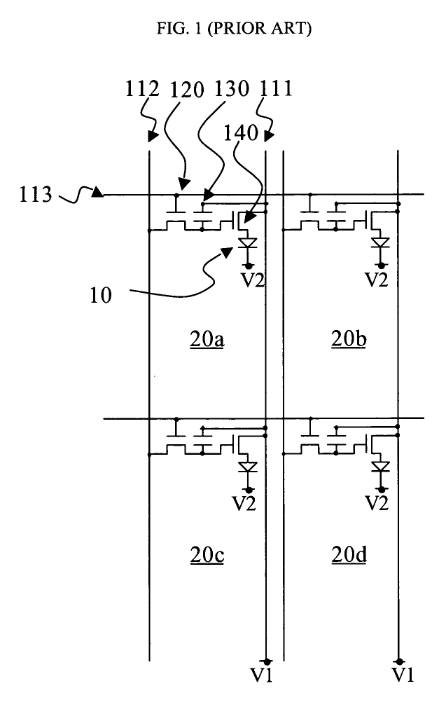

In order to more fully appreciate the invention, aspects of a prior art OLED display will be described with reference to FIGS. 1 to 3.

A simple, prior art active matrix circuit used for driving an OLED display is shown in FIG. 1. A matrix of two rows and two columns with a total of four pixels (pixel 20a, pixel 20b, pixel 20c, and pixel 20d) is shown for illustration, however, this design is typically expanded to a larger number of rows and columns. Each pixel is comprised of an organic light emitting diode, such as organic light emitting diode 10. Driving electronic components are provided such as select transistor 120 and power transistor 140, as well as a storage capacitor 130 associated with pixel 20a. These components are electrically connected to several signal lines including power line 111, data line 112, and select line 113. These components are arranged to drive the organic light emitting diode 10 which is typically formed in a layer over and electrically connected to the circuit components formed on the substrate. The organic light emitting diode includes a lower electrode and an upper electrode and an organic electroluminescent media. The upper electrode is typically formed so as to be common to all the pixels and can be electrically connected to a voltage source such as voltage source V2.

This active matrix drive circuitry operates in a manner well known in the art. Each row of pixels is selected in turn by applying a voltage signal to the select line associated with the row, such as select line 113, which turns on the select transistor, such as select transistor 120, associated with each pixel in that row. The brightness level, or gray scale information, for each pixel is controlled by a voltage signal, and is set on the data lines, such as data line 112. The storage capacitor, such as storage capacitor 130, for each pixel is then charged to the voltage level of the data line associated with that pixel and maintains the data voltage until the row is selected again during the next image frame. The storage capacitor 130 is connected to the gate terminal of the power transistor 140. Power transistor 140 regulates the current flow through its source and drain terminals from the power line 111 to the organic light-emitting diode 10 in response to the voltage level held on its gate terminal by storage capacitor 130, thereby controlling the pixel's brightness. Organic light-emitting diode is supplied power from power line 111 which is connected to a first voltage source (V1) through power transistor 140 and out the common upper electrode connected to a second voltage source (V2). On each row is then unselected by applying a voltage signal to the select line, which turns off the select transistors. The data line signal values are then set to the levels desired for the next row and the select line of the next row is turned on. This is repeated for every row of pixels. During this time, storage capacitor 130 maintains the data signal on the gate of power transistor 140 such that organic light emitting diode continues to emit while the other rows are receiving data.

As such, select lines are signal lines that serve the function of isolating a row of pixels so that the gray scale information can be loaded into the pixels of the row. Select lines, alternately be referred to as gate lines, are scan lines. Data lines are signal lines that provide the gray scale information to the pixels. This gray scale information can be in the form of a voltage or current signal. Data lines can alternately be referred to as source lines. Power lines are signal lines that provide a source of electrical power to the organic light-emitting diodes of the pixels for maintaining the brightness level of the pixel, at least during the time when the pixels row is not selected by the select line. Typically, the power lines provide a source of electrical power to the organic light-emitting diode at all times when the pixels are illuminated. Power lines can alternately be referred to as power supply lines. Many different alternate types of circuit arrangements known in the art having various arrangements and numbers of circuit components and signal lines are constructed with signal lines serving these basic functions, and the present invention can be practiced on these alternate types of circuit arrangements by one skilled in the art. These alternate arrangements include, for example, current mirror type circuits such as shown in U.S. Pat. Nos. 6,091,203, 6,501,466, 6,535,185 and 6,774,877 as well as the pixel circuits shown in U.S. Pat. No. 6,229,506 and the pixel circuit described in U.S. Patent Application Publication 2004/0222746 A1. Although the circuit of this example is shown with the organic light-emitting diode arranged in a particular bias with the cathode connected to the common connection and the anode connected to the power transistor, circuits having the opposite arrangement is also known in the art. Also, although the capacitor is shown connected to the power line, other example circuit arrangements where a separate capacitor signal line is provided are known in the art.

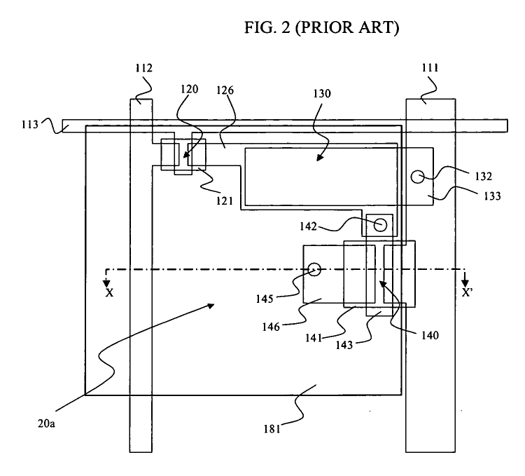

The physical layout view of pixel 20a of the prior art circuit of FIG. 1 as implemented using amorphous silicon type TFT's is shown in FIG. 2. The construction of the various circuit components such as select transistor 120, storage capacitor 130, and power transistor 140 can be seen in FIG. 2. The drive circuitry components are fabricated using conventional integrated circuit and thin film transistor fabrication technologies. Select line 113 is formed in a first conductor layer. Power Line 111 and Data Line 112 are formed in a second conductor layer. An insulator is formed there between in order to electrically isolate these two conductor layers. This configuration permits the data lines and power lines to cross without electrically connecting thereby forming the matrix of pixels. Electrical connections between features formed in the different conductor layers are achieved by forming contact holes, also referred to as vias, through the insulator layers disposed between the conductor layers. The term electrical connection is used in this disclosure to indicate a connection that enables the flow of electrical current. This can be a direct physical connection of two conductive elements. An electrical connection can have electrical resistance. An electrical connection can also be indirectly provided through other circuit components such as transistors or diodes.

A portion of the select line 113 extends to form the gate of select transistor 120. Over this first conductor layer is a first insulator layer (not shown), which is also referred to as the gate insulator layer. Select transistor 120 is formed from a first semiconductor region 121 using techniques well known in the art. The first terminal, which can be either the source or drain terminal, is formed from a portion of data line 112. The second terminal of select transistor 120, terminal 126, extends to form the second capacitor electrode of storage capacitor 130 and also to electrically connect to the power transistor gate electrode 143 of power transistor 140 through contact hole 142. The transistors, such as select transistor 120, are shown as bottom gate type transistors, however, other types such as top gate and dual-gate transistors are also known in the art and can be employed. Similarly, power transistor 140 is formed in a second semiconductor region 141. The first semiconductor region 121 and second semiconductor region 141 are typically formed in the same semiconductor layer over the gate insulator layer. The semiconductor layer is composed of multiple sub-layers such as an intrinsic, or undoped, sub-layer and a doped sub-layer. This semiconductor layer here is amorphous silicon but can also be polycrystalline or crystalline or known semiconductor materials other than silicon, such as organic semiconductors and metal oxide semiconductors. The power transistor gate electrode 143 of power transistor 140 is formed in the first conductor layer. The first terminal of power transistor 140 is formed from a portion of power line 111, as shown. The second terminal 146 of power transistor 140 is formed in the second conductor layer. Storage capacitor 130 is formed between a first capacitor electrode 133 formed in the first conductor layer and the second capacitor electrode formed as a portion of terminal 126 as described above. The gate insulator layer (not shown) is deposited between the first capacitor electrode and the second capacitor electrode. The first capacitor electrode 133 is electrically connected to power line 111 through contact hole 132. Alternate configurations are known in the art where the storage capacitor is not directly connected to the power line but is instead provided a separate capacitor line, which can be maintained at a different voltage level or the same voltage level relative to the power line.

Lower electrode 181 of the organic light emitting diode is formed from a third conductor layer formed over the first and second conductor layers. A second insulator layer (not shown) is located between the lower electrode 181 and the second conductor layer. The lower electrode 181 of the organic light emitting diode is connected to power transistor 140 through contact hole 145 formed in this second insulator layer.

Lower electrode 181 serves to provide electrical contact to the organic electroluminescent media (not shown) of the organic light emitting diodes. Over the perimeter edges lower electrode 181, an inter-pixel insulator layer (not shown) can also be formed to cover the edges of the electrodes and reduce shorting defects as is known in the art. Examples of such inter-pixel insulator layers can be found in U.S. Pat. No. 6,246,179.

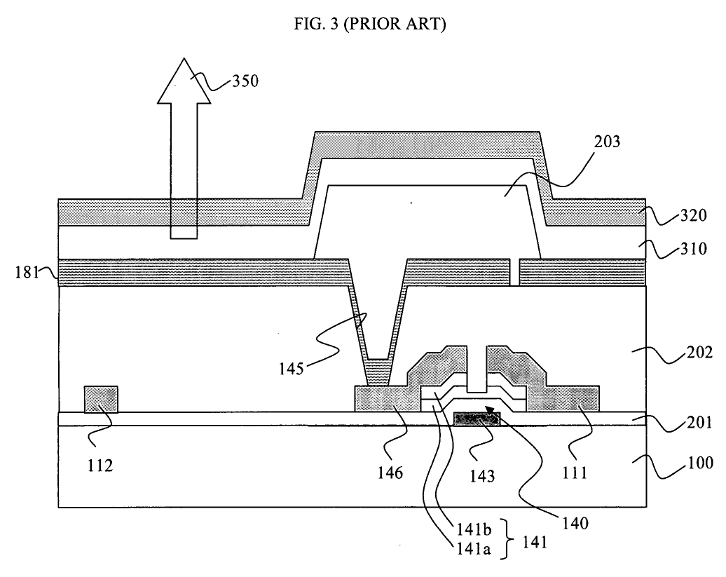

A cross-sectional illustration of the prior art device of FIG. 2 along line X-X′ is shown in FIG. 3. In this cross-sectional view the position of the insulating substrate 100 as well as the positions of the first insulator layer 201 (also referred to as the gate insulator layer) and second insulator layer 202 can be seen. These insulator layers are shown as single layers but can actually comprise several sub-layers of different insulating materials. The construction of the amorphous silicon power transistor 140 is shown. The second semiconductor region 141 is shown with an intrinsic sub-layer 141a and doped sub-layer 141b.

The placement of inter-pixel insulator 203 over the edges of lower electrode 181 is shown. Over lower electrode 181, the organic electroluminescent media 310 is formed. Here the organic electroluminescent media 310 is shown as a single layer, but it is typically composed of a plurality of sub-layers such as a hole injecting layer, hole transporting layer, one or more emitting layers, electron transporting layer, and electron injecting layers. Various constructions and combinations of such layers are known in the art. Above the organic electroluminescent media 310, the upper electrode 320 is formed. Upper electrode 320 is typically common in such active matrix arrangements and serves to provide an electrical connection to the second voltage level as previously described. The lower electrode 181 and upper electrode 320 serve as spaced apart electrodes which provide electrical current to the organic electroluminescent media 310 disposed between said electrodes. When electrically stimulated, the organic electroluminescent media 310 above the lower electrode 181 in the area defined by the opening of the inter-pixel insulator 203 will emit light 350. Light 350 is shown as exiting the top of the device (the direction opposite insulating substrate 100). This configuration is known as a top-emitting configuration. This requires that upper electrode 320 be at least partially transparent. As such, upper electrode 320 is commonly constructed of materials such as indium tin oxide (ITO), indium zinc oxide (IZO), or thin (less than 25 nm) layers of metal such as aluminum or silver. The lower electrode is typically reflective in such a configuration, being constructed at least in part of a reflective metals such as aluminum, aluminum alloys, silver, silver alloys, or molybdenum. The opposite configuration is known in the art where light is viewed through the substrate. This opposite configuration is known as a bottom emitter configuration. In this configuration, the light transmissive and reflective properties of the upper and lower electrodes respectively are reversed from that of the top emitter configuration.

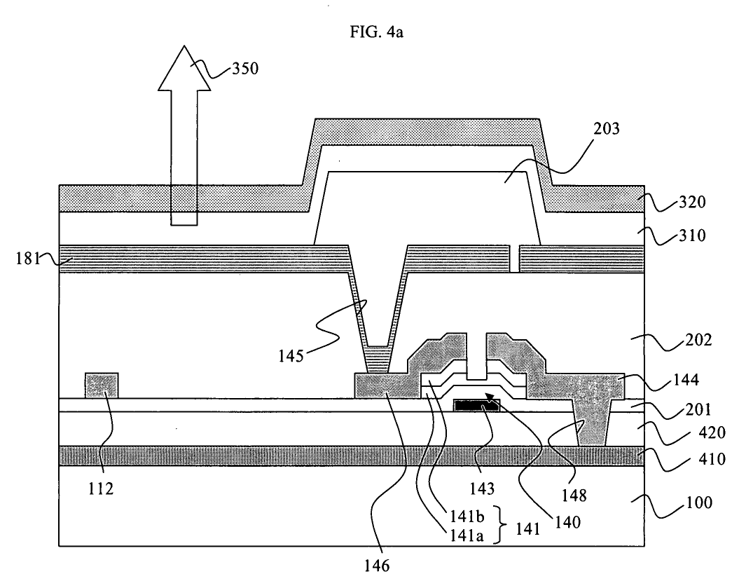

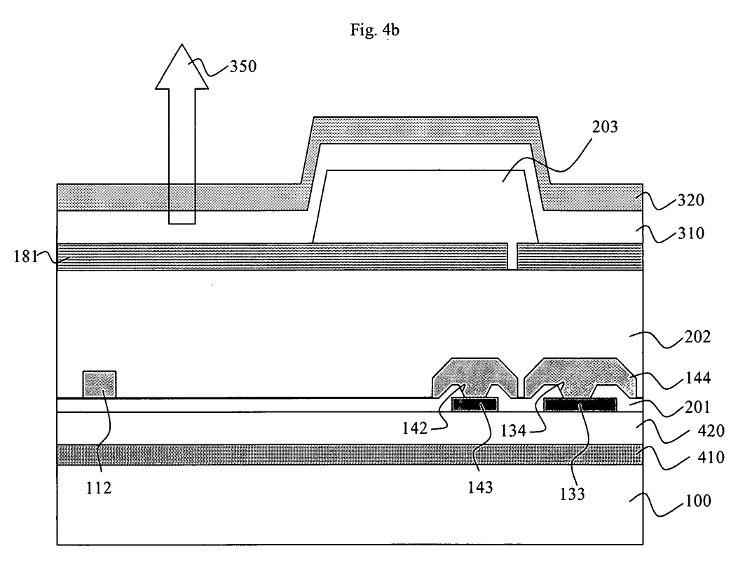

The first embodiment of the present invention will now be described with reference to FIGS. 4a, 4b, 5, 6 and 7. In cases where a component serves the same function as in the prior examples, like numbers are used and detailed descriptions are omitted.

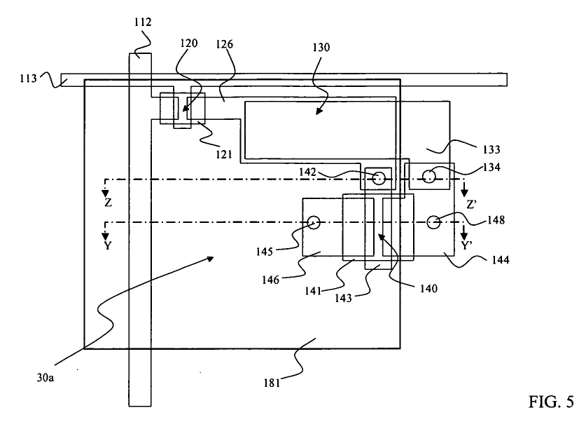

FIG. 5 shows a physical layout view of one pixel, pixel 30a, of an OLED display as implemented using amorphous silicon thin film transistors according to the first embodiment of the present invention. A select transistor 120, storage capacitor 130, and power transistor 140 are provided. A select line 113 and data line 112 are also provided and arranged in the row and column direction as shown. These components are constructed in from a semiconductor layer, a first conductor layer, and a second conductor layer along with several interlayer insulating layers in a similar fashion as described in the previous prior art example. A first cross-sectional illustrations of the pixel through the power transistor along line Y-Y′ is shown in FIG. 4a. A second cross-section illustration of the pixel along line Z-Z′ in shown in FIG. 4b.

In this first embodiment of the present invention, a separate power line is not provided in either the first or second conductor layer. Instead, a lower conductor layer 410 is provided below the thin film transistors, over insulating substrate 100. The lower conductor layer serves to provide electrical connection to a voltage supply for all of the pixels, thereby eliminating the need for separate power lines. This lower conductor layer 410 is formed in a continuous fashion, without patterning under at least the area of all the pixels. That is, the lower conductor layer 410 is preferably deposited over the entire insulating substrate 100 without the need for photolithographic patterning or etching. As such, the lower conductor layer 410 is a continuous conductor layer. Alternately the lower conductor layer can be limited to the area of the substrate under the pixels but not formed along the peripheral of the substrate. This can be achieved by covering the peripheral edge of the substrate with a mask, such as a shadow mask, during the deposition of the lower conductor layer. It this alternate case, the lower conductor layer is still continuous under all the pixels and does not require any precision patterning. As such, the lower conductor layer is still considered continuous. This continuous construction serves to maintain low manufacturing cost.

Insulating substrate 100 is electrically insulating and is preferably glass, such as Corning 1737 glass or the like. Such glass substrates can be processed using many commercially available manufacturing tools, which also serves to maintain low manufacturing cost. However, the present invention can also be practiced on other electrically insulting substrates such as plastic substrates. The lower conductor layer 410 can be chosen from a range of materials similar to those used for the first conductor layer. For example, Chromium or Molybdenum are preferable materials capable of withstanding subsequent processing. Aluminum alloys such as Aluminum-Neodymium alloys can be used if the process temperatures used to fabricate the thin film transistors are kept low, for example less than 350 degrees C. and more preferably less than 300 degrees C. The thickness of the lower metal layer is approximately 500 nm, but can be thinner or thicker depending on the peak electrical current usage of the display.

Over lower conductor layer 410, lower insulator layer 420 is formed. Lower insulator layer 420 serves to electrically isolate lower conductor layer 410 from the other conductive and the semiconductor layer that are used, for example, to form the thin film transistors. Lower insulator layer 420 can be choosen from a wide variety of materials. Preferred materials for use in lower insulator layer 420 include Silicon oxide, silicon nitride, silicon oxy-nitride (SiₓO_{y}N_{z}) which are vacuum deposited by methods such as chemical vapor deposition (CVD), including plasma enhanced chemical vapor deposition (PECVD), or the like. Other preferred materials for use as lower insulator layer 420 include spin-on-glass (SOG) materials, Teflon, polyimide or Benzocyclobutene (BCB), which are deposited by either a vacuum-based method or solution-based, such as spin coating (Spin-on) method. The insulating material selected preferably has a low dielectric constant (∈ᵣ), preferably lower than 7 and more preferably lower than 3. A list of some useful materials for the lower insulating layer 420 along with the deposition method and typical range of dielectric constants of each material is provided below in table 1. These materials are preferably made to be thick such as at least 500 nm and more preferably greater than 1000 nm. By increasing the thickness of lower insulator layer 420 and selecting a material with a low dielectric constant of these materials, parasitic capacitive coupling between lower conductor layer 410 and the signal lines formed in the first and second conductor layers can be reduced. The lower insulator layer 420 can be made of single layer of these materials or multiple layers of these materials, depending on the film stress and adhesion properties.

TABLE 1

| Material | Method | εᵣ |
|---|---|---|
| Polyimides | Spin-on | 3.0˜4.0 |
| Hydrogen Silsesquioxane (HSQ) | Spin-on | 2.9˜3.2 |
| Aromatic Polymer | Spin-on | 2.6˜3.2 |
| B-Staged Polymers (CYCLOTENE ™ and Silk ™) | Spin-on | 2.6˜2.7 |
| Fluorinated Polyimides | Spin-on | 2.5˜2.9 |
| Methyl Silsesquioxane (MSQ) | Spin-on | 2.6˜2.8 |
| Poly (arylene ether) (PAE) | Spin-on | 2.6˜2.8 |
| Teflon/PFTE | Spin-on | 1.9˜2.1 |
| Aerogels/Xerogels (porous silica) | Spin-on | 1.1˜2.5 |
| Doped Spin on Glass (SOG) | Spin-on, | 2.5˜3.2 |
| | CVD | |
| Fluorosilicate Glass (FSG) | CVD | 3.2˜4.0 |
| Diamond-like Carbon (DLC) | CVD | 2.7˜3.4 |
| Black Diamond ™ (SiCOH) | CVD | 2.7˜3.3 |
| Parylene - N, Parylene - F | CVD | 2.4˜2.7 |
| Fluorinated DLC | CVD | 2.4˜2.8 |

Since a power line is not provided, additional electrical connections need to be provided for some of the circuit components such as power transistor 140 and storage capacitor 130. As can be seen in FIG. 5, first terminal 144 of power transistor 140 is formed as from isolated section of the second conductor layer. First terminal 144 and second terminal 146 provide the electrical connections to the source and drain terminals of power transistor 140. The second terminal 146 can serve as the source terminal and first terminal 144 can serve as the drain terminal if the organic light emitting diode is constructed with an upper cathode and lower anode as indicated. However, the opposite configuration is also known in the art and can be applied to the present invention such that second terminal 146 can serve as the drain terminal and first terminal 144 can serve as the source terminal. Also the roles of these terminals can be switched during operation. As such, one skilled in the art will realize that the source and drain terminal indications are interchangeable and can be switched to suit a particular device construction, pixel design, or driving operation method.

Connections between the various layers are made through contact holes. FIG. 4a and FIG. 4b provide illustrations of the different types of contact holes such as contact hole 148 (shown in FIG. 4a) through first insulator layer 201 and lower insulator layer 420 enabling electrical connections to the lower conductor layer 410 as well as contact holes such as contact holes 142 and 134 (shown in FIG. 4a) through first insulator layer 201 enabling electrical connections between the first and second conductor layers. According to the present invention, first terminal 144 is electrically connected to the lower conductor layer 410 through contact hole 148 formed in lower insulator layer 420. In this example, first terminal 144 serves to provide a direct electrical connection between the lower conductor layer 410, through contact hole 148 to the power transistor 140 so that electrical current can flow between the lower conductor layer 410 and the first terminal 144 of power transistor 140 and the lower electrode 181 and upper electrode 320 of light-emitting diode 10. That is, the first terminal 144 of power transistor 140 is directly connected to the lower conductor layer 410 through contact hole 148. Other, less direct, electrical connections can also be made by one skilled in the art. For example, additional metal connections (wiring) or additional transistors could be provided between the power transistor and the lower conductor layer to provide the electrical connection between the power transistor and the lower conductor layer through contact hole 148.

Electrical connection is also made between storage capacitor 130 and the lower conductor layer 410. This is achieved by electrically connecting first capacitor electrode 133 to the first terminal 144 of the power transistor 140 through contact hole 134. Since first terminal 144 is electrically connected to the lower conductor layer 410 through contact hole 148, electrically connection is thereby also provided to the first capacitor electrode 133.

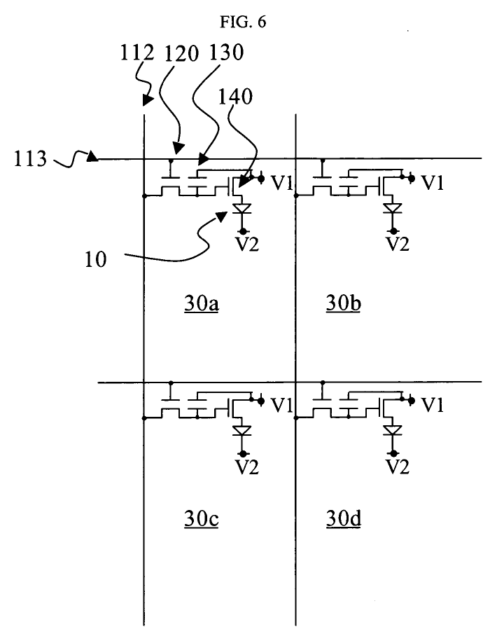

The circuit established by these connections to the lower conductor layer according to the present invention is further illustrated in the circuit diagram shown in FIG. 6. Two rows and two columns of pixels are shown, including pixels 30a, 30b, 30c, and 30d. As with the prior art example, this design can be expanded to a larger number of rows and columns by one skilled in the art. The electrical connections between components such as select transistor 120, storage capacitor 130, power transistor 140, data line 112, and select line 113 are shown. The circuit of the present invention operates in a similar fashion to the prior art circuit shown in FIG. 1, however, as previously described, the first voltage source (V1) is electrically connected all of the pixels by way of a common connection to the lower conductor layer. As such, individual power lines for each column (or row) are not required. A common electrical connection to the second voltage source (V2) continues to be provided by the upper electrode as in the prior art example.

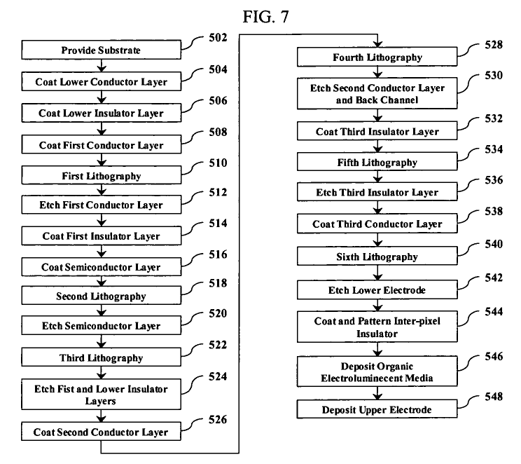

A preferred fabrication process sequence for constructing the OLED device according to the first embodiment of the present invention will now be described with reference to FIG. 7 and also with references to FIG. 4a, FIG. 4b and FIG. 5. The process begins by providing an insulating substrate 100 (step 502) and coating the lower conductor layer 410 over the surface of the substrate (step 504). This coating can be performed by an evaporation or sputtering method. The lower conductor layer 410 is preferably formed over the entire substrate, without patterning, thereby avoiding the costs of such patterning. The lower insulator layer 420 is then coated (step 506) over the lower conductor layer 410 using a method such as CVD or spin-coating depending on the material as previously described. Next the first conductive layer is deposited (step 508) and a first photolithography operation is performed (step 510) to create a pattern. A photolithography step is a patterning operation that can involve several sub-tasks such as cleaning, photoresist coating, exposure, backing, and developing. Furthermore, the photoresist is removed after an etching step. Photolithography operations are known in the art and are not described in detail.

The first conductive layer is then etched (step 512) using either a wet (acid) or dry (plasma) etching method in order to form features such as select line 113 and power transistor gate electrode 143. Wet and dry etching methods and chemistries are well known in the art. Next the first insulator layer is deposited by PECVD (step 514). The semiconductor layer is also deposited by PECVD (step 516) also by PECVD, preferably in the same cluster tool without breaking the sealed vacuum condition. As previously described, the semiconductor layer is preferably comprised of two distinct sub-layers, an intrinsic layer and a doped layer deposited sequentially over the first insulator layer

A second lithography step (step 518) is performed to pattern the semiconductor layer into features such as first semiconductor region 121 and second semiconductor region 141. The semiconductor layer is then etched (step 520) using, for example, fluorine (SF₆) or Chlorine (Cl₂) based plasma etching.

A third lithography step (step 522) is performed to create the pattern for the contact holes between the features formed from the first conductor layer and the second conductor layer, such as contact hole 134 and contact hole 142. The third lithography step (step 522) also provides the pattern for the contact holes formed between lower conductor layer 410 and features formed from the second conductor layer, such as contact hole 148. Following the patterning, these contact holes are then formed by an etch step (step 524). This etch step is performed such that in the areas of contact hole 134 and contact hole 142, the first insulator layer is removed with the etch stopping on (exposing) the features of the first conductor layer. In the area of contact hole 148 which does not contain any features from the first conductor layer, the etching continues through the lower insulator layer 420, stopping on the lower conductor layer 410. Etch step 524 can be a single etch process of a combination of etch processes (or sub-steps) designed to removed the materials of the first insulator layer and then the lower insulator layer. The etch process of step 524 can be a chemical (wet) etch or a plasma (dry) etch, or a combination thereof. For example, an etch process using a fluorine based plasma with CF₄, SF₆, or CHF₃ can be used in an etch process to etch through a silicon nitride first insulator layer and also through a lower insulator layer constructed from SOG or BCB. In this case, the same etching process is used to etch through the first insulator layer and lower insulator layer to form contact holes to the first conductor layer (such as contact holes 142 and 134) and to form the contact hole to the lower conductor layer (such as contact hole 148). That is, these contact holes are simultaneously formed in the same etching process. In this case the first and lower conductor layers should have a top surface that is resistant to fluorine plasma etching such as a chromium surface layer. Alternately, wet etches such as buffered hydrofluoric (HF) acid can be used for materials such as silicon oxide or nitride and some SOG materials.

In an alternate example, a silicon nitride can be chosen for the first insulator layer and a polymer material chosen for the lower insulator layer. In this case, a first etching process using a wet etch process such as buffered hydrofluoric acide can be used to etch through the first insulator layer to form contact holes to the first conductor layer (such as contact holes 142 and 134) and partially form the contact hole to the lower conductor layer (such as contact hole 148). A second etching process can then be performed to complete the contact hole to the lower conductor layer (contact hole 148). This second etching process can utilize, for example, oxygen (O₂) based plasmas.

By simultaneously patterning the contact holes to the lower conductor (such as contact hole 148) layer in the same lithography step as the contact holes between other layers, such as contact holes between the first and second conductor layers (for example contact holes 142 and 134), the device of the present invention can be constructed at low cost. By also forming the lower conductor layer 410 and lower insulator layer 420 without patterning as previously described, the device of the present invention can be constructed using the same number of patterning steps as prior art devices. Therefore, manufacturing cost can be kept low. By forming these contact holes in a single etching process, manufacturing cost can be kept low. Alternately, by using two different etching processes as described above with a single, simultaneous patterning step, more choices of materials for the different insulator layers can be realized.

The second conductor layer is then coated (step 526) and a fourth lithography step (step 528) is performed to form the patterns for features to be formed from the second conductor layer such as data line 112, first terminal 144, and second terminal 146. Etch step 530 is then performed to etch the second conductive layer. Etch step 530 is also designed to etch any exposed doped sub-layer portions of the second semiconductor layer, such as doped sub-layer 141b. This process is known as the back-channel etch and is used to isolate the source and drain terminals of the TFT's leaving only intrinsic or undoped portions of the semiconductor material in the channel region. As such, etch 530 can be a single or multiple sub-step etch process.

A third insulator layer is then coated (step 532). The third insulator layer passivates the semiconductor surface of the back channel of the semiconductor regions in addition to insulating the features of the second conductor layer from conductive features formed in higher layers. The third insulator layer also preferably serves to planarize the topography of the underlying TFT and signal line features. Again, the third insulator can be constructed of multiple sub-layers to serve these functions. For example a silicon nitride sub-layer can be employed to seal the back channel region and a second organic planarizing sub-layer can be employed to planarize the topography. A fifth lithography step is performed (step 534) to create the pattern for contact holes through the third insulator layer, such as contact hole 145. These contact holes are etched in step 536, which are provided by multiple sub-steps to etch through different materials.

A third conductor is then coated (step 538) and a sixth lithography step (step 540) and an etch step (step 542) are performed to form the features from this third conductor layer, such as lower electrode 181. An inter-pixel insulator 203 can be employed over lower electrode 181, as previously described. Preferred materials for inter-pixel insulator 203 are photo-imagable polymers as is known in the art. Such materials can be spin coated, exposed and developed to form the desired structure and then remain on devices as permanent features. The coating and patterning of the inter-pixel insulator (step 544) occurs after the formation of the lower electrodes. Next, the organic electroluminecent media 310 is deposited (step 546) followed by the deposition of the upper electrode 320 (step 548). These depositions typically occur in a vacuum system and can be performed through shadow masks to create desired patterns as is known in the art. Alternate deposition approaches, such as ink jet deposition or transfer from a donor substrate by laser thermal transfer are known in the art and can also be employed. Additional steps such as encapsulation, application of desiccant, application of color filters as known the art can also be employed as needed.

In the above fabrication process, manufacturing cost is kept low by patterning the contact holes to the lower conductor layer (such as contact hole 148) in the same patterning step as other contact holes (such as contact holes 142 and 134), in this case contact holes between the first and second conductor layers in step 524. In alternate embodiments of the present invention, the contact holes to the lower conductor layer can be patterned in other steps, such as the step for patterning the contact holes between the second and third conductor layer. In this alternate embodiment, the electrical connection between the power transistor and the lower conductor layer would have to be achieved by connecting the first terminal up to a conductive element formed at least partially from the third conductor layer which in turn is electrically connected down to the lower conductor layer through a contact hole formed through the lower, first and second insulator layers. Such a configuration requires the contact hole to be formed through more insulator layers and can also reduce the space available for the lower electrode compared to the example of the first embodiment. However, some advantage according to the present invention can still be achieved and by formulating the contact holes to the lower conductor layer at the same time as other contact holes, the manufacturing cost can again be kept low.

The above device structure and fabrication process as described with reference to FIGS. 4a, 4b, 5, 6 and 7 represents one example fabrication process appropriate for a bottom gate TFT device structure particularly useful for amorphous silicon based TFT's. However, the present invention can also be applied to other device structures and fabrication processes having more or fewer steps and more or fewer layers, which are known to those skilled in the art. For example, the present invention can be applied to devices having more or fewer conductor and insulator layers. The present invention can also be applied to different TFT structures such as top gate or dual gate TFT's as well as polysilcon based TFT's by one skilled in the art.

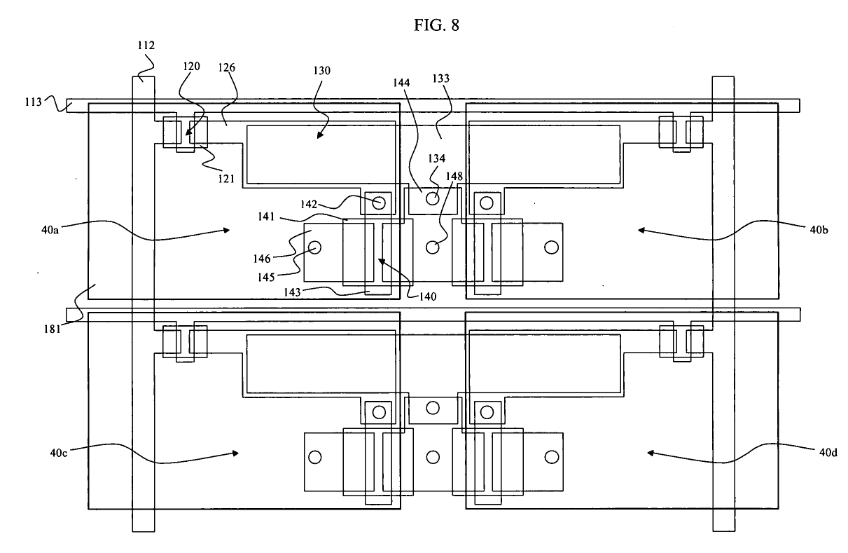

A second embodiment of the present invention will now be described with reference to FIG. 8. FIG. 8 shows a physical layout view of driving circuitry for four example pixels in two rows and two columns according to this second embodiment. Pixel 40a and 40b are arranged in a first and second column respectively within a first row. Pixel 40c and 40d are arranged in a first and second column respectively within a second row. These pixels are constructed of components similar to those described for the first embodiment and where a component serves the same function, like numbers are used and detailed descriptions are omitted. In this second embodiment, the connection to the lower conductor layer shared by two pixels in adjacent columns such as pixel 40a and pixel 40b. In this case first terminal 144 is shared by the power transistors of the two adjacent pixels and electrical connection is provided by terminal 144 through contact hole 148 to the lower conductor layer for both pixels. Alternate electrically connection configurations utilizing a plurality of metallic wires or additional components such as additional thin film transistors can also be employed by one skilled in the art. Similarly, the first capacitor electrode 133 is shared between the adjacent pixels and contact hole 134 serves to provide a connection to the first terminal 144. By sharing components or electrical connections through the contact hole among adjacent pixels, the amount of surface area needed to construct the pixels can be reduced. This permits the pixels to be made smaller, thereby enabling a higher resolution display. Reducing the number of contact holes to the lower conductor layer also reduces the surface topography variations in the display.

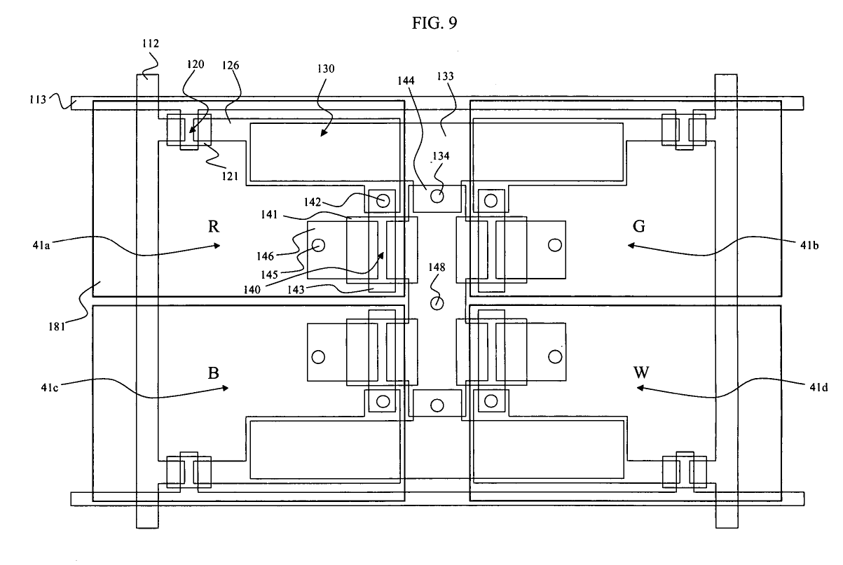

A third embodiment of the present invention will now be described with reference to FIG. 9. FIG. 9 shows a physical layout view of driving circuitry for four example pixels in two rows and two columns according to this third embodiment. Pixel 41a and 41b are arranged in a first and second column respectively within a first row. Pixel 41c and 41d are arranged in a first and second column respectively within a second row. These pixels can, for example, be used to provide red (R), green (G), blue (B), and white (W) emission, thereby forming an RGBW type display. These pixels are constructed of components similar to those described for the first embodiment and where a component serves the same function, like numbers are used and detailed descriptions are omitted. In this third embodiment, the connection to the lower conductor layer shared by the four adjacent pixels as shown. In this case first terminal 144 is shared by the power transistors of all four of the adjacent pixels and contact hole 148 serves to electrically connect all pixels to the lower conductor layer. Alternate electrically connection configurations utilizing a plurality of metallic wires or additional components such as additional thin film transistors can also be employed by one skilled in the art. By sharing the contact hole and electrical connection between the four adjacent pixels, the amount of surface area needed to construct the pixels can be reduced. This permits the pixels to be made smaller, thereby enabling a higher resolution display. Reducing the number of contact holes to the lower conductor layer also reduces the surface topography variations in the display.

The invention has been described in detail with particular reference to certain preferred embodiments thereof, but it will be understood that variations and modifications can be effected within the spirit and scope of the invention.

### Parts List

light-emitting diode
20a pixel
20b pixel
20c pixel
20d pixel
30a pixel
30b pixel
30c pixel
30d pixel
40a pixel
40b pixel
40c pixel
40d pixel
41a pixel
41b pixel
41c pixel
41d pixel
100 substrate
111 power line
112 data line
113 select line
120 select transistor
121 first semiconductor region
126 terminal
130 storage capacitor
132 contact hole
133 first capacitor electrode
134 contact hole
140 power transistor
141 second semiconductor region
141a intrinsic sub-layer
141b doped sub-layer
142 contact hole
143 power transistor gate electrode
144 first terminal
145 contact hole
146 second terminal
148 contact hole
181 lower electrode
201 first insulator layer
202 second insulator layer
203 inter-pixel insulator
310 organic electroluminescent media
320 upper electrode
350 light
410 lower conductor layer
420 lower insulator layer
502 step
504 step
506 step
508 step
510 step
512 step
514 step
516 step
518 step
520 step
522 step
524 step
526 step
528 step
530 step
532 step
534 step
536 step
538 step
540 step
542 step
544 step
546 step
548 step

1. An OLED device comprising:
a) an electrically insulating substrate;
b) a plurality of light emitting pixels formed over the substrate wherein each pixel includes first and second spaced apart electrodes and organic electroluminescent media disposed between the first and second electrodes;
c) a first thin film transistor associated with a first pixel and disposed above the substrate and having a gate electrode, a semiconductor region, a source terminal and a drain terminal;
d) a continuously formed conductive layer positioned under the pixels and disposed above the substrate and disposed below the first thin film transistor and the organic electroluminescent media;
e) an insulator layer disposed between the continuous conductor layer and the thin film transistor and having a first contact hole; and
f) means for providing an electrical connection from the continuous conductor layer, through the first contact hole to either the source terminal or drain terminal of the first thin film transistor so that electrical current flows between the continuous conductor layer, the source terminal and drain terminal and the first and second spaced apart electrodes of the first pixel.

2. The OLED device of claim 1 wherein the insulating substrate includes glass.

3. The OLED device of claim 1 wherein the insulator layer includes a material having silicon oxide, silicon nitride, polymide, or benzocyclobutene.

4. The OLED device of claim 1 wherein the continuous conductor layer includes a material having chromium or molybdenum.

5. The OLED device of claim 1 wherein the light emitting pixels emit light from the direction opposite the electrically insulating substrate.

6. The OLED device of claim 1 further including a second pixel and a second thin film transistor having a gate electrode, a semiconductor region, a source terminal and a drain terminal disposed above the continuous conductor layer and including means for providing an electrical connection from the continuous conductor layer to source terminal and drain terminal of the second thin film transistor through the first contact hole and to the first and second spaced apart electrodes of the second pixel.

7. The OLED device of claim 6 further including a third and a fourth pixel and a third and a fourth thin film transistor each having a gate electrode, a semiconductor region, a source terminal and a drain terminal disposed above the continuous conductor layer and including means for providing an electrical connection from the continuous conductor layer to the source terminals and drain terminals of the third and fourth thin film transistors through the first contact hole and to the first and second spaced apart electrodes of the third and fourth pixels respectively.

8. A method of making an OLED device comprising:
a) providing an insulating substrate;
b) forming a continuous conductor over the substrate;
c) forming a first insulator layer over the continuous conductor layer;
d) forming a gate electrode over the insulator layer;
e) forming a source and drain terminals;
f) forming a second insulator layer between the gate electrode and the source and drain terminals;
g) simultaneously patterning and then forming a first contact hole through the second insulator and a second contact hole through the second and first insulator layers; and
h) providing spaced apart first and second electrodes and organic electroluminescent media between the spaced apart first and second electrodes and electrically connecting the source terminal or the drain terminal to the first electrode.

9. The method of claim 8 wherein the first and second contact holes are simultaneously formed by an etching process.

10. The method of claim 8 wherein the first contact hole is formed by a first etching process and the second contact hole is partially formed by the first etching process and completed by a second etching process.
